(19) United States
(12) Patent Application Publication
(10) Pub. No.: US 2018/0126284 A1
(43) Pub. Date: May 10, 2018

(54) Amusement Park Game System and Gaming Method Thereof

(71) Applicant: ORIGIN MEDIA CO. LTD., TAIPEI CITY (TW)

(72) Inventors: JYH-CHAU TARNG, TAIPEI CITY (TW); SHUANG-YU WU, TAIPEI CITY (TW)

(21) Appl. No.: 15/378,018

(22) Filed: Dec. 13, 2016

(30) Foreign Application Priority Data
Nov. 8, 2016 (TW) 105217029

(51) Int. Cl. A63F 13/825; H04M 1/725; A63F 13/31; A63F 13/211; A63F 13/212; A63F 13/355

(52) U.S. Cl. CPC A63F 13/825; H04M 1/7253; H04M 1/72544; H04W 4/003; A63F 13/211; A63F 13/212; A63F 13/355; A63F 13/31

(57) ABSTRACT

The present invention is an amusement park game system and gaming method thereof, mainly applied for digital pet raising simulation game, comprising a mobile device application, a wearable device, field system, and a cloud system. After a parent downloaded the application in his/her smart mobile device, it can connect the wearable device of the child, such that the parent can use the mobile device application to assign task to the wearable device for the child to perform the task and obtain game points. Therefore, the child can use the game points on taking care of the digital pet, so as to raise his/her own digital pet. The data can be store in the mobile device application of the parent and the cloud system. The cloud system can also be utilized to update the content of the game for the wearable device, so as to enrich the overall content and enhance the variety thereof.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention comprises a technology of amusement park game system and gaming method thereof, which, in particular, indicates an application that combines wearable devices and mobile devices and additionally has field system and cloud system for the users to enjoy various motion sensing educational games and pet raising games and store relative information in the mobile device application and cloud system, so as to enhance the overall utility for the amusement park game system and gaming method thereof.

### Description of Related Arts

Nowadays, smart mobile devices have been commonly used. Even children have their personal mobile phones. Besides, mobile phones usually have access to the internet. Consequently, children can easily download games that are not suitable for their age from the internet, while the parents can constantly stay around or check if there is improper game in the cell phones of the children. If the children become addicted to the improper game or health adverse game, it can easily influence their studies and mental and physical health.

In addition, children electronic products in the market, such as children watches, are usually designed according to parent's considerations and mostly focus on safety concerns. Therefore, they mostly provide global positioning system, monitoring device, emergency calling function, and parent talking function, which are basically designed for the considerations of children's safety and convenience, rather than for the functions of gaming or learning. As a result, the overall utility of these conventional devices is limited.

Hence, it should develop a combination of a wearable device, such as a children watch, and a mobile device, to allow the parent to use the mobile device to interact with the children watch of his/her child. Besides, the children watch of the child also allows the child to play games and raise pets, which develops his/her responsibility and brings up the overall utility of the device.

### SUMMARY OF THE PRESENT INVENTION

An object of the present invention is to provide an amusement park game system and gaming method thereof that mainly combines mobile device application and wearable device(s) and connects field system and cloud system, such that the user can perform various motion sensing educational games and pet raising games to obtain game points and use the game points to take care of digital pet(s), so as to raise his/her own digital pet(s). Besides, these motion sensing educational games can also enhance the hand-eye coordination, agility, sense of balance, responsibility, etc. of the user. In addition, the parents can check the progress and content of the games and assign tasks to the children, which increase the interaction between the children and the parents.

In order to achieve the above objects, the present invention provides an amusement park game system, mainly applied for digital pet raising simulation games, comprising a mobile device application, a wearable device, field system, and a cloud system. a mobile device application comprising a database, a pet store, and a general store respectively for storing data, purchasing pet supplies, and purchasing general goods; a wearable device connected with said mobile device application via internet wherein said wearable device comprises a processor, a memory, a wireless transmission system, and a plurality of sensors interconnected in the inside thereof and provides a plurality of motion sensing educational games and pet raising games; a cloud system respectively connected with said mobile device application, said wearable device, and said field system, adapted to store and backup all the data via internet.

In a preferred embodiment, the mobile device application is to be installed in various smart mobile devices. The wearable device is specifically a children watch having a watch surface adapted to display time and to replace backgrounds. The sensors of the wearable device comprise g-sensor, gyroscope, accelerometer, etc., so as for performing motion sensing games, comprising finger-guessing game, jogging, jumping, etc.

In order to achieve the above objects, the present invention provides a gaming method of amusement park game system, mainly applied for digital pet raising simulation game, allowing mutual reference for the monitor and player thereof, comprising the following steps: starting the application on the smart mobile device and assigning task to the player by the monitor; starting the wearable device by the player to receive the task assigned by the monitor and to start to perform the task, wherein the player obtains game points after the task is accomplished, wherein the data is allowed to be stored in the cloud system and the smart mobile device of the monitor; starting the wearable device by the player to enter the pet raising game, so as for the player to feed, clean, and dress up digital pet and to be allowed to store the data in the cloud system and the smart mobile device of the monitor; starting the wearable device by the player to enter the motion sensing educational game, so as to perform various motion sensing activities and educational games and to be allowed to store the data in the cloud system and the smart mobile device of the monitor; starting the wearable device by the player to enter a field system via internet, wherein the field system reads and identifies the information of the wearable device and connects the wearable device, so as to perform various level beating games or tasks in the field system and to be allowed to store the results of the games in the cloud system and the smart mobile device of the monitor; starting the wearable device by the player to enter a field system via internet to purchase pet goods and general goods or to redeem the game points into goods in the field system and to be allowed to store the data in the cloud system and the smart mobile device of the monitor; sending task to the wearable device daily or in particular festivals by the cloud system, so as for the player to perform the tasks and obtain game points or basic items after the player starts the wearable device.

In a preferred embodiment, it allows the player to friend with another wearable device and gives present to another wearable device after the player starts the wearable device. Besides, it allows a plurality of friended wearable devices to battle game with each other via internet.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a structural perspective view of the amusement park game system according to the present invention.

FIG. 2 is a preferred flow diagram of the gaming method of the amusement park according to the present invention.

### DETAILED DESCRIPTION OF THE PREFERRED EMBODIMENT

The following is to use specific embodiments to illustrate an implementation of the present invention, which person skilled in the art can easily understand other additional advantages and functions of the present invention based on the disclosure of the present specification.

The following describes the embodiments of the present invention with figure references. It shall be noted that the appended figures are simplified perspective drawings to only perspectively illustrate basic concepts of the present invention. Therefore, the drawings just provide examples and structures that are related to the present invention, but provide illustrations of actual quantities, shapes, and sizes of the elements of actual implementations. The forms, quantities, sizes, and ratio of the elements for actual implementations may be changed based on the actual needs, which are accounted here in advance.

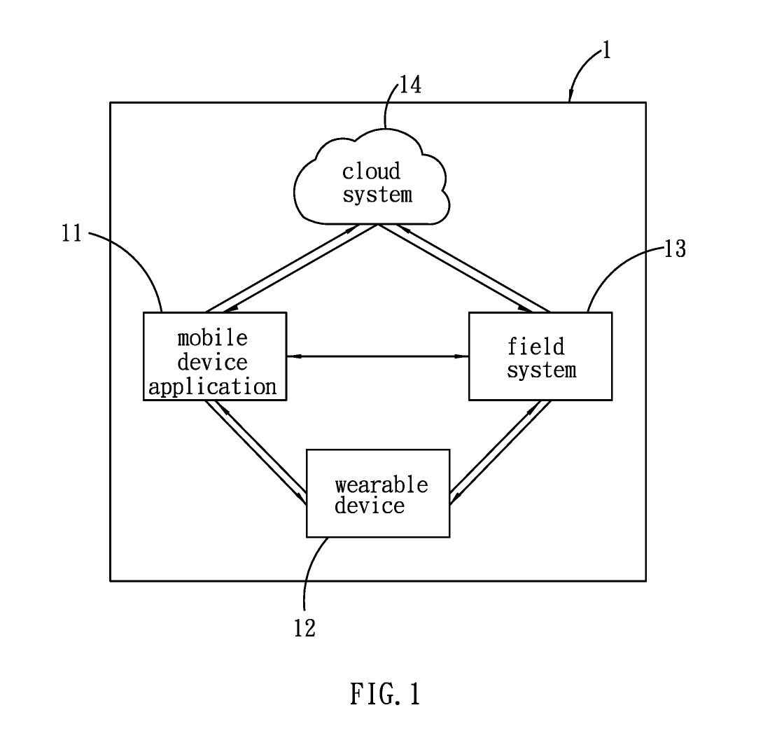

First, FIG. 1 is a structural perspective view of the amusement park game system according to the present invention. Referring to the drawings, an amusement park game system 1 according to the present invention, mainly applied for digital pet raising simulation games, comprises a mobile device application 11, a wearable device 12, a field system 13, and a cloud system 14.

The mobile device application 11 comprises a database, a pet store, and a general store respectively for storing data, purchasing pet supplies, and purchasing general goods. The wearable device 12 connected with the mobile device application 11 via internet. The wearable device 12 comprises a processor, a memory, a wireless transmission system, and a plurality of sensors interconnected in the inside thereof and provides a plurality of motion sensing educational games and pet raising games. The field system 13 respectively connected with the mobile device application 11 and the wearable device 12. The field system 13 provides a plurality of gaming areas and pet-caring areas for the wearable device 12 to conduct various games and pet-caring actions in the field system 13. It also allows game data to be transmitted to the database of the mobile device application 11. The cloud system 14 is respectively connected with the mobile device application 11, the wearable device 12, and the field system 13 and adapted to store and backup all the data via internet.

In a preferred embodiment, the mobile device application 11 is to be installed in smart mobile devices with different systems (e.g. Android or IOS). The wearable device 12 is specifically a children watch, which has a watch surface adapted to display time and to replace backgrounds and can display digital or dial clock. The sensors of the wearable device 12 comprise g-sensor, gyroscope, accelerometer, etc., so as to sense the activity of hands of the players or other target to meet the requirements of motion sensing games.

The wearable device 12 provides various built-in motion sensing or educational mini-games. Game points can be obtained after a mini-game or an assigned task is accomplished. Besides, buying goods in the stores in the mobile device application 11 offers game points as well. In addition, participating the activities

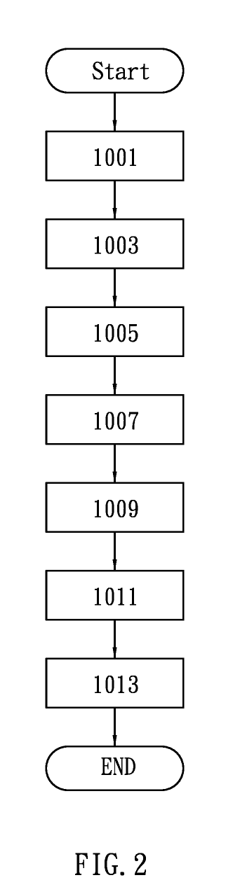

FIG. 2 illustrates a preferred flow diagram of the gaming method of the amusement park according to the present invention. Referring to the figure, the gaming method of the present invention comprises the following steps:

Step 1001: starting the application on the smart mobile device and assigning task to the player by the monitor.

Step 1003: starting the wearable device by the player to receive the task assigned by the monitor and to start to perform the task, wherein the player obtains game points after the task is accomplished, wherein the data is allowed to be stored in the cloud system and the smart mobile device of the monitor.

Step 1005: starting the wearable device by the player to enter the pet raising game, so as for the player to feed, clean, and dress up digital pet and to be allowed to store the data in the cloud system and the smart mobile device of the monitor.

Step 1007: starting the wearable device by the player to enter the motion sensing educational game, so as to perform various motion sensing activities and educational games and to be allowed to store the data in the cloud system and the smart mobile device of the monitor.

Step 1009: starting the wearable device by the player to enter a field system via internet, wherein the field system reads and identifies the information of the wearable device and connects the wearable device, so as to perform various level beating games or tasks in the field system and to be allowed to store the results of the games in the cloud system and the smart mobile device of the monitor.

Step 1011: starting the wearable device by the player to enter a field system via internet to purchase pet goods and general goods or to redeem the game points into goods in the field system and to be allowed to store the data in the cloud system and the smart mobile device of the monitor.

Step 1013: sending task to the wearable device daily or in particular festivals by the cloud system, so as for the player to perform the tasks and obtain game points or basic items after the player starts the wearable device.

Specifically speaking, by the above steps, a parent download the application 11 on the smart mobile devices thereof, the child wears the wearable device 12, the mobile device application 11 and the wearable device 12 are connected, the parent uses the mobile device application 11 to assign task(s) to the wearable device 12, the wearable device 12 of the child receives the task and allows the task to be performed, and the child obtains corresponding game points after accomplishing the task. The task can be all kinds of different motion sensing game or educational game, such as jogging, walking, finger guessing, jumping, answering life common sense questions, etc., so as to train the hand-eye coordination, agility, sense of balance, etc. of the child.

After the child obtains the game points, he/she can directly use them on the digital pet(s) of his/her own in the wearable device 12, such as to feed, clean, or dress up the digital pet(s). This develops the sense of responsibility of the child.

Besides, the wearable device 12 can connect the field system 13 to perform level beating of the games in the field system directly or to purchase the goods that the digital pet needs in the store. The above information can all be directly backuped and stored in both the mobile device application 11 and the cloud system 14 at the same time, such that the latest information can be acquired or updated at any time.

In addition, after the player starts the wearable device 12, he/she can mutually friend another wearable device 12 and give gift to another wearable device 12. A plurality of wearable devices 12 that are friends can battle the game with each other or one another or team up to conduct level beating together via internet.

Further, the cloud system 14 can send daily task or send designated task in special festival by the approval of the parent to the wearable device 12. When the task is accomplished, the player can also obtain game points. The game points can also be directly used in the stores of the field system to redeem goods. Also, the types of the game in the field system can be based on different needs or have new versions, so as to enrich the overall contents and enhance the variety thereof.

Although the above description and figures have disclosed preferred embodiments of the present invention, it shall be noted that there are still various addings, modifications, and alternatives that can possibly be utilized on the preferred embodiments of the present invention without exceeding the spirit and scope of the concept of the present invention defined by the appended claims. Those skilled in the art can understand that the present invention can be utilized with various modifications of forms, structures, arrangements, ratios, materials, elements, and units. Hence, the embodiments disclosed in the present specification shall be considered describing the present invention, instead of limiting the present invention. The scope of the present invention shall be defined by the appended claims and cover the legal equivalents, but be limited in the above description.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An amusement park game system, mainly used for digital pet raising simulation game, comprising:
a mobile device application comprising a database, a pet store, and a general store respectively for storing data, purchasing pet supplies, and purchasing general goods;
a wearable device connected with said mobile device application via internet, wherein said wearable device comprises a processor, a memory, a wireless transmission system, and a plurality of sensors interconnected in the inside thereof and provides a plurality of motion sensing educational games and pet raising games;
a field system respectively connected with said mobile device application and said wearable device, wherein said field system provides a plurality of gaming areas and pet-caring areas for said wearable device to conduct various games and pet-caring actions in said field system and allow game data to be transmitted to said database of said mobile device application; and
a cloud system respectively connected with said mobile device application, said wearable device, and said field system, adapted to store and backup all the data via internet.

2. The amusement park game system, as recited in claim 1, wherein said mobile device application is to be installed in various smart mobile devices.

3. The amusement park game system, as recited in claim 1, wherein said wearable device is specifically a children watch having a watch surface adapted to display time and to replace backgrounds.

4. The amusement park game system, as recited in claim 1, wherein said sensors of said wearable device comprises g-sensor, gyroscope, and accelerometer.

5. A gaming method of amusement park game system, mainly applied for digital pet raising simulation game, allowing mutual reference for the monitor and player thereof, comprising the following steps:
starting the application on the smart mobile device and assigning task to the player by the monitor;
starting the wearable device by the player to receive the task assigned by the monitor and to start to perform the task, wherein the player obtains game points after the task is accomplished, wherein the data is allowed to be stored in the cloud system and the smart mobile device of the monitor;
starting the wearable device by the player to enter the pet raising game, so as for the player to feed, clean, and dress up digital pet and to be allowed to store the data in the cloud system and the smart mobile device of the monitor;
starting the wearable device by the player to enter the motion sensing educational game, so as to perform various motion sensing activities and educational games and to be allowed to store the data in the cloud system and the smart mobile device of the monitor;
starting the wearable device by the player to enter a field system via internet, wherein the field system reads and identifies the information of the wearable device and connects the wearable device, so as to perform various level beating games or tasks in the field system and to be allowed to store the results of the games in the cloud system and the smart mobile device of the monitor;
starting the wearable device by the player to enter a field system via internet to purchase pet goods and general goods or to redeem the game points into goods in the field system and to be allowed to store the data in the cloud system and the smart mobile device of the monitor;
sending task to the wearable device daily or in particular festivals by the cloud system, so as for the player to perform the tasks and obtain game points or basic items after the player starts the wearable device.

6. The gaming method of amusement park game system, as recited in claim 5, allowing the player to friend with another wearable device and give present to another wearable device after the player starts the wearable device.

7. The gaming method of amusement park game system, as recited in claim 6, allowing a plurality of friended wearable devices to battle game with each other via internet.
